(19) United States
(12) Patent Application Publication
(10) Pub. No.: US 2012/0002233 A1
(43) Pub. Date: Jan. 5, 2012

(54) IMAGE FORMING APPARATUS, CONTROL METHOD, AND CONTROL APPARATUS

(75) Inventor: Satoshi HASEGAWA, Shizukoka-ken (JP)

(73) Assignees: Toshiba Tec Kabushiki Kaisha, Tokyo (JP); Kabushiki Kaisha Toshiba, Tokyo (JP)

(21) Appl. No.: 13/175,092

(22) Filed: Jul. 1, 2011

Related U.S. Application Data
(60) Provisional application No. 61/361,334, filed on Jul. 2, 2010.

(51) Int. Cl. G06K 15/02; G06F 1/26

(52) U.S. Cl. 358/1.14; 713/300

(57) ABSTRACT

There is provided an image forming apparatus that allows image forming processes of a more number of apparatuses with limited power. The image forming apparatus includes: a job acquiring unit that acquires an image forming job giving an instruction to form an image; an electricity consumption amount acquiring unit that acquires the sum of electricity consumption amount in a plurality of apparatuses of which the sum of electricity consumption amount including the electricity consumption amount of the image forming apparatus is limited at a predetermined maximum electricity consumption amount or less; a determining unit that determines whether or not the sum of electricity consumption amount that the electricity consumption amount acquiring unit acquires is equal to or less than a predetermined reference value, which is smaller than the maximum electricity consumption amount; and an image forming process control unit that performs an image forming job that the job acquiring unit acquires, when the determining unit determines that the sum of electricity consumption amount is equal to or less than the reference value.

### CROSS-REFERENCE TO RELATED APPLICATION

This application is based upon and claims the benefit of priority from U.S. provisional application 61/361334, filed on Jul. 2, 2010; the entire contents of which are incorporated herein by reference.

### FIELD

Embodiments described herein relate to control of operation of an image forming apparatus.

### BACKGROUND

In electrophotographic type image forming apparatuses, an image is formed by fixing a toner image, which is transferred on a sheet, onto the sheet by heating and pressing the toner image. A large amount of power is consumed by the fixing in the processes of the image forming apparatuses. In detail, a large amount of power is consumed by warming-up, printing, and standing-by of keeping the temperature of the fixing apparatus constant, which are performed when the power of the image forming apparatuses is turned on.

When a plurality of such image forming apparatuses is used at one place, it is necessary to keep the power for the apparatuses under the available maximum power (or current) for that place. Therefore, it is required to limit the number of apparatuses that are installed or increase the available maximum power such that the sum of power used when all of the image forming apparatuses perform fixing is less than the maximum power, for example, even if the power that each of the image forming apparatuses uses is not over the maximum power (or current).

### DESCRIPTION OF THE DRAWINGS

FIG. 1 is a system configuration diagram illustrating the configuration of a system of an embodiment.

FIG. 2 is a functional block diagram showing the function of a monitoring apparatus.

FIG. 3 is a functional block diagram showing the function of an image forming apparatus.

FIG. 4 is a diagram showing an example of transition of the sum of power consumption of a monitoring target apparatus of a monitoring apparatus.

FIG. 5 is a flowchart showing a flow of an image forming process by an image forming apparatus of an embodiment.

FIG. 6 is a functional block diagram illustrating the function of a monitoring apparatus of an embodiment.

FIG. 7 is a functional block diagram illustrating the function of an image forming apparatus of an embodiment.

FIG. 8 is a flowchart showing the flow of an image forming process in a system of an embodiment.

FIG. 9 is a functional block diagram illustrating the function of a monitoring apparatus of an embodiment.

FIG. 10 is a diagram showing an example of transition of the sum of power consumption of the monitoring target apparatus of the monitoring apparatus.

### DETAILED DESCRIPTION

According to an embodiment, an image forming apparatus includes a job acquiring unit, an electricity consumption amount acquiring unit, a determining unit, and an image forming process control unit.

The job acquiring unit acquires an image forming job giving an instruction to form an image. The electricity consumption amount acquiring unit acquires the sum of electricity consumption amount in a plurality of apparatuses of which the sum of electricity consumption amount including the electricity consumption amount of the image forming apparatus is limited to a predetermined maximum electricity consumption amount or less. The determining unit determines whether or not the sum of electricity consumption amount that the electricity consumption amount acquiring unit acquires is equal to or less than a predetermined reference value, which is smaller than the maximum electricity consumption amount. The image forming process control unit performs an image forming job that the job acquiring unit acquires, when the determining unit determines that the sum of electricity consumption amount is equal to or less than the reference value.

Hereinafter, embodiments are described with reference to the drawings.

### First Embodiment

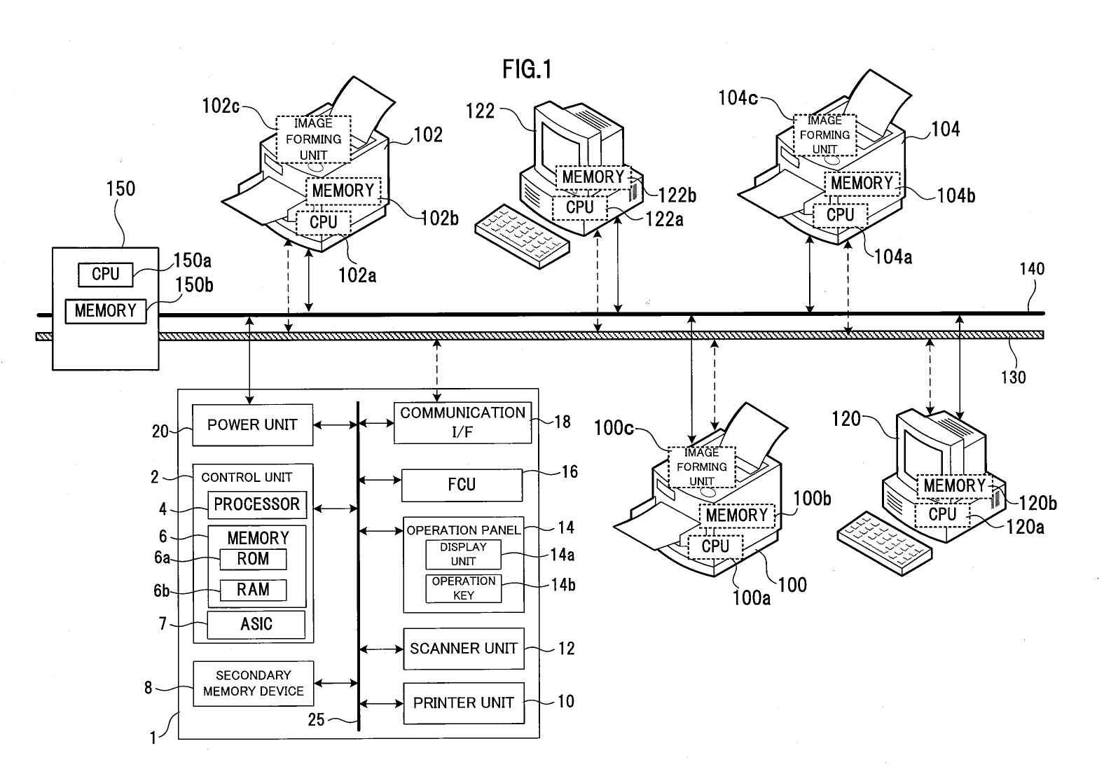

FIG. 1 is a system configuration diagram illustrating the configuration of a system including an image forming apparatus 1, other image forming apparatuses 100, 102, and 104, and computers 120 and 122. The system is a system configuration including the image forming apparatus 1 according to the embodiment, other image forming apparatuses 100, 102, and 104, the computers 120 and 122, and a monitoring apparatus 150.

The image forming apparatus 1, other image forming apparatuses 100, 102, and 104, the computers 120 and 122, and the monitoring apparatus 150 are connected through a network 130. Further, the apparatuses are connected to a power network 140 supplied with power and the apparatuses are supplied with power through the monitoring apparatus 150. Further, available power of the apparatuses is limited to a predetermined maximum power by the monitoring apparatus 150.

Further, in the following description, although the image forming apparatus 1 is described as operating on the basis of power (W) monitored by the monitoring apparatus 150, when supplied voltage is constant, current (I) flowing for a monitoring target apparatus is monitored and the image forming apparatus 1 may operate on the basis of the current.

The image forming apparatus 1 of the embodiment includes a control unit 2, a secondary memory device 8, a printer unit 10, a scanner unit 12, an operation panel 14, a facsimile control unit (FCU) 16, a communication interface (communication I/F) 18, and a power unit 20. The components of the image forming apparatus 1 are connected through a bus 25.

The control unit 2 functions, using a processor 4, memory 6, and an operating system (OS).

The processor 4 is a CPU (Central Processing Unit) or an MPU (Micro Processing Unit).

The memory 6 is a so-called primary memory device. For example, the memory is a semiconductor memory. The memory 6 includes a ROM (Read Only Memory) 6a storing a control program of the processor 4 and a RAM (Random Access Memory) 6b providing the processor 4 with a general work area.

The control unit 2 controls the printer unit 10, the scanner unit 12, the operation panel 14, the FCU 16, the communication I/F 18, and the power unit 20 on the basis of the control program and the like stored in the ROM 6a or the secondary memory device 8. The control unit 2 may further include various image process functions. Further, the control unit 2 may include an ASIC (Application Specific Integrated Circuit) 7 that performs a portion of or all of the functions of the image forming apparatus 1.

The secondary memory device 8 stores application programs and the OS. The application programs include programs that perform a copy function, a print function, a scanner function, a facsimile function, and a network file function, which are the functions of the image forming apparatus 1. Further, the application programs further include an application for web clients (web browser) or another application.

The secondary memory device 8 stores image data generated by the scanner unit 12 reading a document or data acquired from an external apparatus connected to the communication I/F 18 through the network 130. Further, in the embodiment, the secondary memory device 8 temporarily stores a print job transmitted from a client terminal (for example, the computers 120 and 122) connected through the network 130, until the print job is performed.

As the secondary memory device 8, for example, a magnetic memory device, such as a hard disk drive, an optical memory device, a semiconductor memory device (a flash memory and the like), or certain combinations of the memory devices. The secondary memory device 8 appropriately stores software update, protected electronic documents, text data, account information, and policy information and the like.

The printer unit 10 forms an image corresponding to the image data of the document read by the scanner unit 12 or an image corresponding to the data transmitted through the network 130 from the client terminal, such as the external computer 120, onto a sheet.

The scanner unit 12 includes a built-in scanning reading unit that reads a document as an image, a platen, and an automatic document feeding apparatus that feeds the document to the a reading position. The scanning reading unit of the scanner unit 12 reads the document set on the platen or the automatic document feeding apparatus.

The operation panel 14 includes a touch panel type of display unit 14a and various operation keys 14b. The display unit 14a displays setting items relating to print conditions, for example, the paper size, the number of copies, print concentration setting, or consummation (binding, bending). The operation key 14b, for example, includes a numerical keypad, a reset key, a stop key, and a start key and the like. A user can set various processes or the items displayed on the display unit 14a by inputting the processes or the items, using the display unit 14a or the operation key 14b.

The facsimile control unit (FCU) 16 controls transmission and reception of facsimile in the image forming apparatus 1.

The communication I/F 18 is an interface that connects the image forming apparatus 1 with an external apparatus, such as the image forming apparatus 100 or the computer 120, through the network 130. The communication I/F 18 is connected with an external apparatus through the network 130 in appropriate wireless communication or wire communication based on IEEE802. 15, IEEE802. 11, IEEE802. 3, and IEEE 1284 and the like, for example, Bluetooth (registered trademark), infrared connection, and optical connection. The communication I/F 18 includes a buffer and temporarily stores some of or the entire data received through the network 130 in the buffer. The control unit 2 communicates with the computer 120 or apparatuses, such as the image forming apparatus 100, which are connected through the network 130, through the communication I/F 18.

The power unit 20 is supplied with necessary power from the power network 140.

Next, the image forming apparatuses 100, 102, and 104 are image forming apparatuses, which are the same as the image forming apparatus 1, operated by power supplied through the monitoring apparatus 150. The image forming apparatus 100 includes a CPU 100a that is a processor, a memory 100b, and an image forming unit 100c that performs an image forming process. The image forming apparatuses 102 and 104 have the same configuration. Similar to the image forming apparatus 1, the image forming apparatuses 100, 102, and 104 can also perform an image forming process by performing a job, when acquiring an image forming job through the network 130. Further, the image forming apparatuses 100, 102, and 104, similar to the image forming apparatus 1, may include a scanner unit or an operation panel or an FCU and the like.

The image forming apparatuses 100, 102, and 104 are supplied with power through the power network 140.

Next, the computer 120 and computer 122 are computers that are supplied with power through the monitoring apparatus 150, in the system. The computers 120 and 122 include CPUs 120a and 122a, which are processors, and memories 120b and 122b, respectively.

The monitoring apparatus 150 is disposed at not a monitoring target apparatus, but a power supplier, and monitors whether the sum of power used by the monitoring target apparatus exceeds the predetermined maximum power. In the embodiment, the monitoring apparatus 150 monitors the power used by the image forming apparatus 1, the image forming apparatuses 100, 102, and 104, and the computers 120 and 122, shown in FIG. 1.

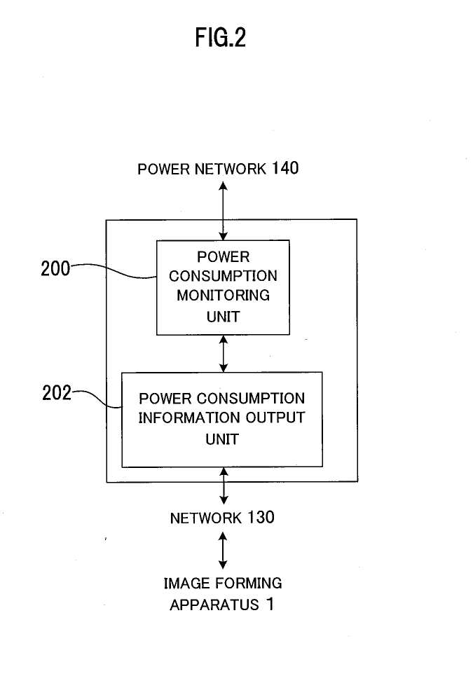

Further, the monitoring apparatus 150 is also connected to the network 130. Although the details are illustrated in the functional block of the monitoring apparatus 150 shown in FIG. 2, the monitoring apparatus 150 outputs information representing the total power consumption used by the monitoring target apparatus at that point of time to the image forming apparatus 1 through the network 130, in response to a request from the image forming apparatus 1.

The monitoring apparatus 150 includes a processor, such as a CPU 150a, and a memory 150b, and performs various processes by performing the functions described above or the functions illustrated in FIG. 2.

Next, control of used power in the image forming apparatus 1, which is performed by the image forming apparatus 1 of the embodiment is described.

First, the function of the monitoring apparatus 150 included in the system of the embodiment is described. FIG. 2 is a functional block diagram showing the function of the monitoring apparatus 150.

The monitoring apparatus 150 of the embodiment includes a power consumption monitoring unit 200 and a power consumption information output unit 202.

The power consumption monitoring unit 200 monitors the total power consumption that is the sum of power consumption used by the monitoring target apparatus of the monitoring apparatus 150. In the embodiment, the monitoring target apparatuses of the monitoring apparatus 150 are, as described above, the image forming apparatus 1, the image forming apparatuses 100, 102, and 104, and the computers 120 and 122, such that the monitoring apparatus 150 monitors the total power consumption that is the sum of power consumption of the apparatuses. Further, the power consumption monitoring unit 200 can stop power supply, for example, when the total power consumption reaches a predetermined maximum power.

The power consumption information output unit 202 transmits the total power consumption to the image forming apparatus 1 through the network 130, when there is a request of the total power consumption from the image forming apparatus 1.

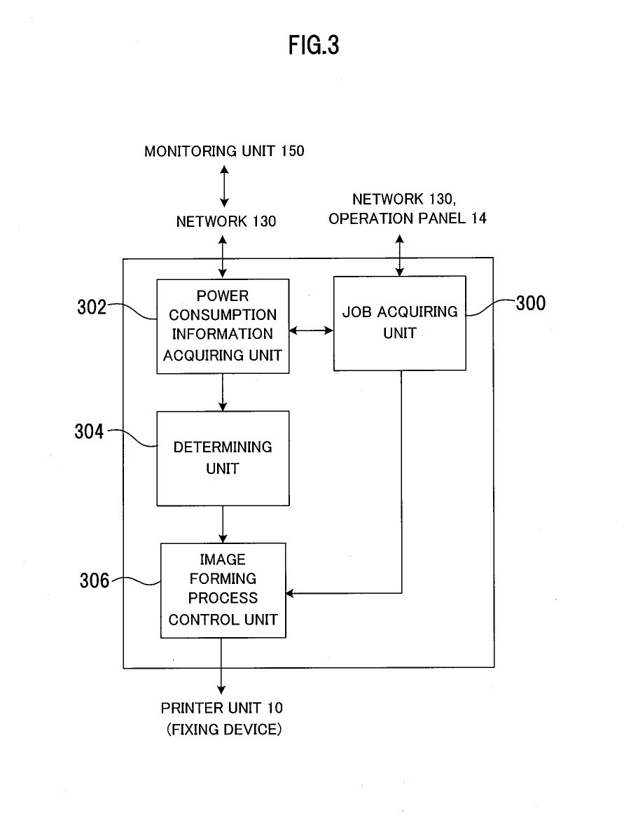

Next, the function of the image forming apparatus 1 of the embodiment is described. FIG. 3 is a functional block diagram showing the function of the image forming apparatus 1.

The image forming apparatus 1 of the embodiment includes a job acquiring unit 300, a power consumption information acquiring unit 302, which is an electricity consumption amount acquiring unit, a determining unit 304, and an image forming process control unit 306.

The job acquiring unit 300 acquires an image forming job. The image forming job includes a print job acquired from a client terminal, such as the computer 120, through the network 130, or a copy job acquired by an operation input in the operation panel 14.

The power consumption information acquiring unit 302 acquires the total power consumption of the monitoring target apparatus of the monitoring apparatus 150 from the monitoring apparatus 150 through the network 130, when the job acquiring unit 300 acquires an image forming job.

The determining unit 304 determines whether the total power consumption acquired by the power consumption information acquiring unit 302 exceeds a limiting power value that is a predetermined reference value.

The “limiting power value” is a reference value for determining whether to perform an image forming process in the image forming apparatus 1. The determining unit 304 determines whether the total power consumption acquired by the power consumption information acquiring unit 302 is equal to or less than the limiting power value or not, when the job acquiring unit 300 acquires an image forming job.

Although the limiting power value may be set at any level, the limiting power value may be set to a value less than the maximum power, as much as the maximum power consumption that is likely to be used by one image forming apparatus 1, for example. When the limiting power value is set as described above and the total power consumption is the same power value as the limiting power value, the power consumption does not exceed the maximum power, even though the image forming apparatus 1 operates. Further, the limiting power value may be stored in advance in a secondary memory device 8 or the memory 6 to be read out and determined during determining and may be stored in the monitoring apparatus 150 or an external storage area, such as an external server, to be acquired from the external storage area for determining.

The image forming process determining unit 306 performs an image forming job acquired by the job acquiring unit 300, when the determining unit 304 determines that the total power consumption is equal to or less the limiting power value. In detail, for the printer unit 10, the image forming process control unit 306 implements an image-forming-possible state by heating the fixing device up to the fixing temperature by supplying power to the fixing device and, performs printing or copying.

When the determining unit 304 determines that the total power consumption is larger than the limiting power value, the image forming process control unit 306 does not perform the image forming job acquired by the job acquiring unit 300. In this case, the image forming process control unit 306 stands by until the total power consumption becomes the limiting power value or less and can perform the image forming job when the determining unit 304 determines that the total power consumption is equal to or less than the limiting power value.

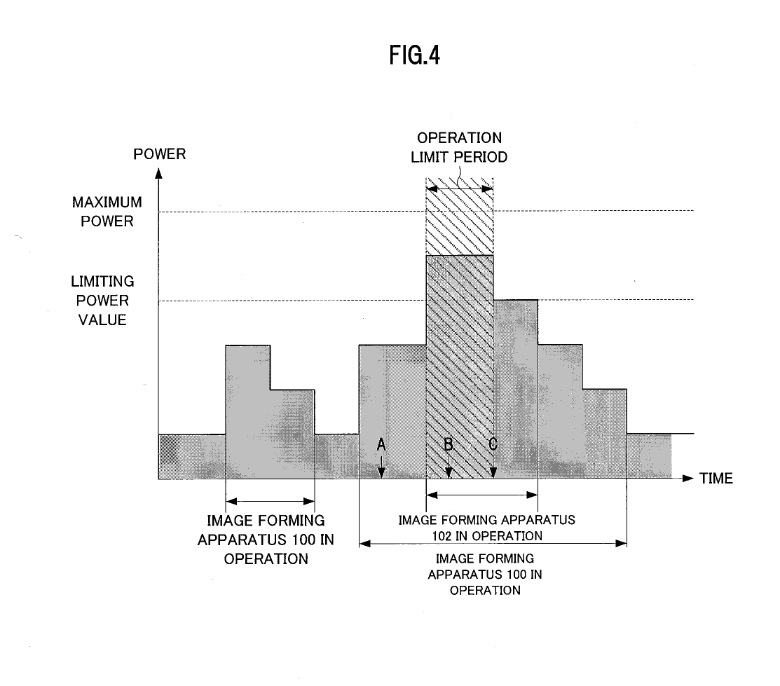

An example of transition of the power consumption monitored by the monitoring apparatus 150 is shown in FIG. 4. In the power transition diagram of FIG. 4, first, the image forming apparatus 100 starts and performs image forming, from a low power consumption state in which the image forming apparatus or the computer, which is the monitoring target of the monitoring apparatus 150, is in stand-by state, such that the power consumption increases. Thereafter, the operation is finished and the power consumption decreases, and then, the image forming apparatus 100 performs image forming again and the power consumption increases.

For example, at the timing indicated by an arrow A in FIG. 4, when the image forming apparatus 1 acquires an image forming job, the determining unit 302 determines that the total power consumption acquired by the power consumption information acquiring unit 300 is equal to or less than the limiting power value. Accordingly, in this case, the image forming apparatus 1 can perform the image forming job.

Subsequently, in FIG. 4, the image forming apparatus 102 starts operating while the image forming apparatus 100 operates. The total power consumption is over the limiting power value at the timing shown as an operation limit period in FIG. 4. Accordingly, for example, at the timing indicated by an arrow B, when the image forming apparatus 1 acquires an image forming job, the determining unit 304 determines that the total power consumption is larger than the limiting power value. Accordingly, during the period shown as the operation limit period in FIG. 4, the image forming apparatus 1 cannot perform the image forming job.

Thereafter, when the timing proceeds to the timing indicated by an arrow C, the image forming apparatus 1 can perform the image forming job, because the total power consumption becomes the limiting power value. Accordingly, for example, when the image forming job, which is acquired at the timing indicated by the arrow B but cannot be performed, is in a stand-by state, the image forming job can be performed at the timing indicated by the arrow C. Further, in FIG. 4, when the image forming apparatus 1 acquires an image forming job after the arrow C, the image forming job can be performed because the total power consumption is equal to or less than the limiting power value.

According to the configuration and function of the image forming apparatus 1 of the embodiment, described above, it is possible to perform an image forming process such that the sum of power consumption does not exceed the maximum power, within a power supply unit that limits the sum of power consumption at a predetermined power. Therefore, it is possible to install more image forming apparatuses within the unit without constructing the power supply environment to change the maximum power of the power supply unit. Accordingly, it is possible to install a necessary number of image forming apparatuses, regardless of the limit in the maximum power.

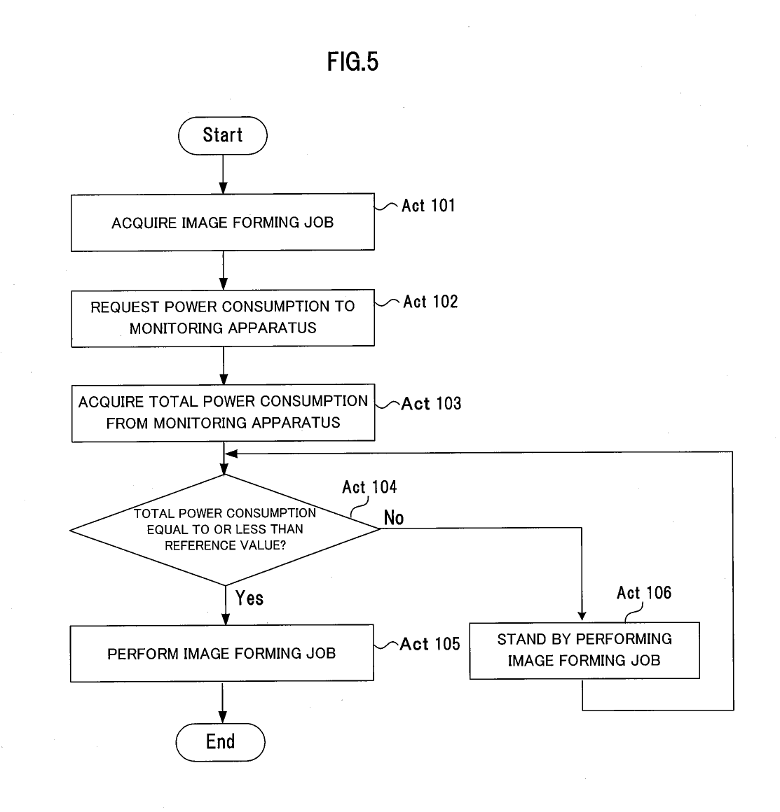

Next, the flow of the image forming process by the image forming apparatus 1 of the embodiment is described. FIG. 5 is a flowchart showing the flow of an image forming process by the image forming apparatus of the embodiment.

First, the job acquiring unit 300 acquires an image forming job (Act 101). The image forming job, as described above, is a print job from a client terminal or a copy job generated by operating the operation panel 14.

Next, the power consumption information acquiring unit 302 requests the total power consumption from the monitoring apparatus 150 (Act 102).

Next, the power consumption information output unit 202 of the monitoring apparatus 150 outputs the total power consumption that is monitored by the power consumption monitoring unit 200 to the image forming apparatus 1 and the power consumption information acquiring unit 302 acquires the total power consumption (Act 103).

Next, the determining unit 304 determines whether the acquired total power consumption is equal to or less than the limiting power value (Act 104).

When the total power consumption is equal to or less than the limiting power value (Yes in Act 104), the image forming process control unit 306 performs the image forming process, using the printer unit 10 on the basis of the image forming job acquired by the job acquiring unit 300 (Act 105).

On the other hand, when the total power consumption is larger than the limiting power value (No in Act 104), the image forming process control unit 306 does not perform the image forming job and stands by (Act 106). Further, the determining unit 304 repeats determining until the total power consumption acquired by the power consumption information acquiring unit 302 becomes equal to or less than the limiting power value.

The above description is the flow of the image forming process by the image forming apparatus of the embodiment.

Further, although it is described that the determining is repeated until the total power consumption becomes equal to or less than the limiting power value in the process flow described above when the total power consumption is larger than the limiting power value, it is not limited thereto. For example, when the determining is repeated a predetermined times that is set in advance or for a predetermined time and the total power consumption is still not equal to or less than the limiting power value, the user may be informed that the job cannot be performed and the job may be canceled.

Further, when the whole image forming apparatuses, which are the monitoring targets of the monitoring apparatus 150, including the image forming apparatuses 100, 102, and 104 has the function of the image forming apparatus 1, it is possible to increase the number of image forming apparatuses that can be installed, such that it is possible to more efficiently use power.

### Second Embodiment

Next, a second embodiment is described. Further, in the embodiment, the functions of an image forming apparatus and a monitoring apparatus are partially different from those of the first embodiment, such that the apparatuses are described as an image forming apparatus 1′ and a monitoring apparatus 150′. Further, in the following description, the same configurations as the first embodiment are designated by the same reference numerals and repetitive description is not provided.

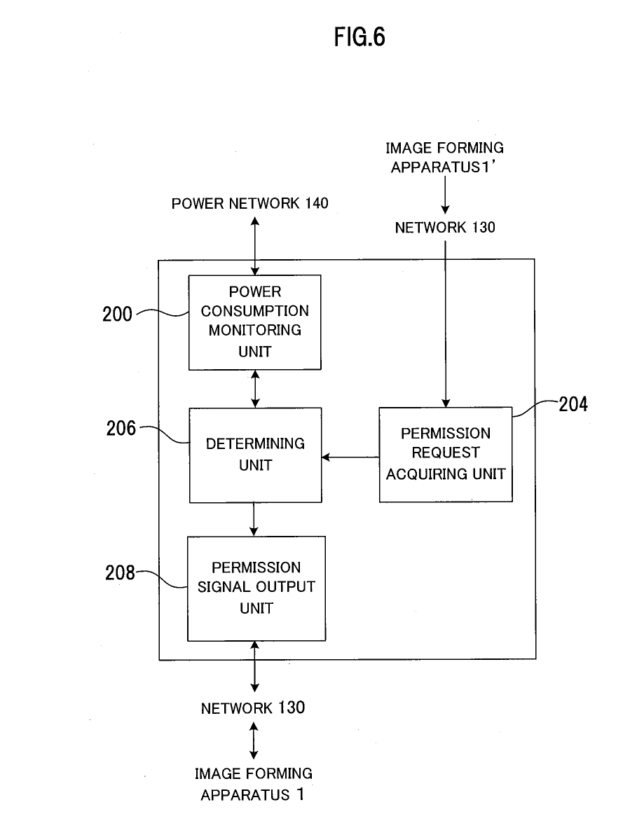

FIG. 6 is a functional block diagram illustrating the function of a monitoring apparatus 150′ of the embodiment. Further, the system configuration composed of the image forming apparatus 1′ and the monitoring apparatus 150′ of the embodiment and other image forming apparatuses or computers is the same as that in the first embodiment, such that the description of the system configuration is not provided.

The monitoring apparatus 150′ of the embodiment is different from that of the first embodiment in having a portion of the function of the image forming apparatus 1 in the first embodiment.

The monitoring apparatus 150′ of the embodiment includes a power consumption monitoring unit 200, a permission request acquiring unit 204, a determining unit 206, and a permission signal output unit 208.

The power consumption monitoring unit 200 monitors power consumption of monitoring target apparatuses, similar to the first embodiment.

When a signal of requesting permission to perform an image forming job of the image forming apparatus 1′ is output from the image forming apparatus 1′, as described later, the permission request acquiring unit 204 acquires the request signal.

When the permission request acquiring unit 204 acquires a request signal of permission to perform the image forming job, the determining unit 206 determines whether the total power consumption at the point of time is equal to or less than a limiting power value. The total power consumption is acquired from the power consumption monitoring unit 200.

When the determining unit 206 determines that the total power consumption is equal to or less than the limiting power value, the permission signal output unit 208 outputs a signal of permission to perform the image forming job to the image forming apparatus 1′.

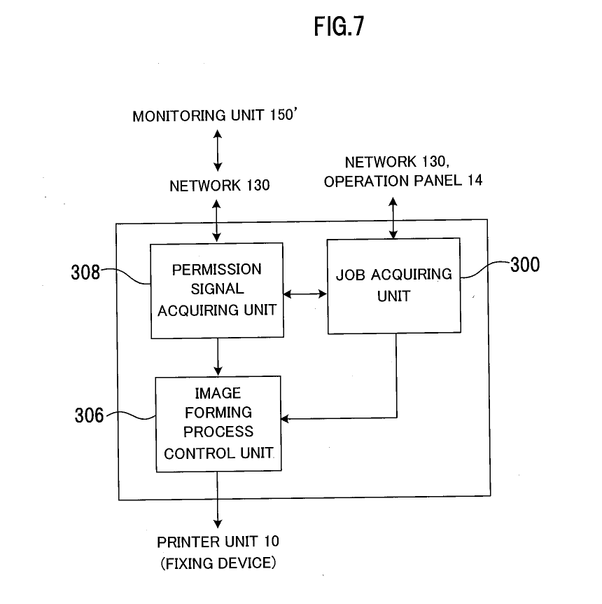

Next, the function of the image forming apparatus 1′ of the embodiment is described. FIG. 7 is a functional block diagram illustrating the function of the image forming apparatus 1′ of the embodiment.

The image forming apparatus 1′ of the embodiment includes a job acquiring unit 300, a permission signal acquiring unit 308, and image forming process control unit 306.

The job acquiring unit 300, similar to the first embodiment, acquires a print job, as an image forming job, from a client terminal through the network 130, and acquires a copy job generated by an operation input through the operation panel 14.

When the job acquiring unit 300 acquires an image forming job, the permission signal acquiring unit 308 requests a permission signal that permits performing of the image forming job to the monitoring apparatus 150′. When the determining unit 206 described above determines that the total power consumption is equal to or less than the limiting power value and the permission signal output unit 208 outputs a permission signal, the monitoring apparatus 150′ acquires the output permission signal.

When the permission signal acquiring unit 308 acquires the permission signal that permits performing of the image forming job, the image forming process control unit 306 performs an image forming process, using the printer unit 10 on the basis of the image forming job acquired by the job acquiring unit 300.

The above description is the configuration and function of the monitoring apparatus 150′ and the image forming apparatus 1′ of the embodiment.

According to the embodiment, it is possible to perform an image forming process such that the image forming apparatus 1′ does not exceed the maximum power, even if the monitoring apparatus 150′, which is an external apparatus of the image forming apparatus 1, has the function of determining whether the image forming process can be performed.

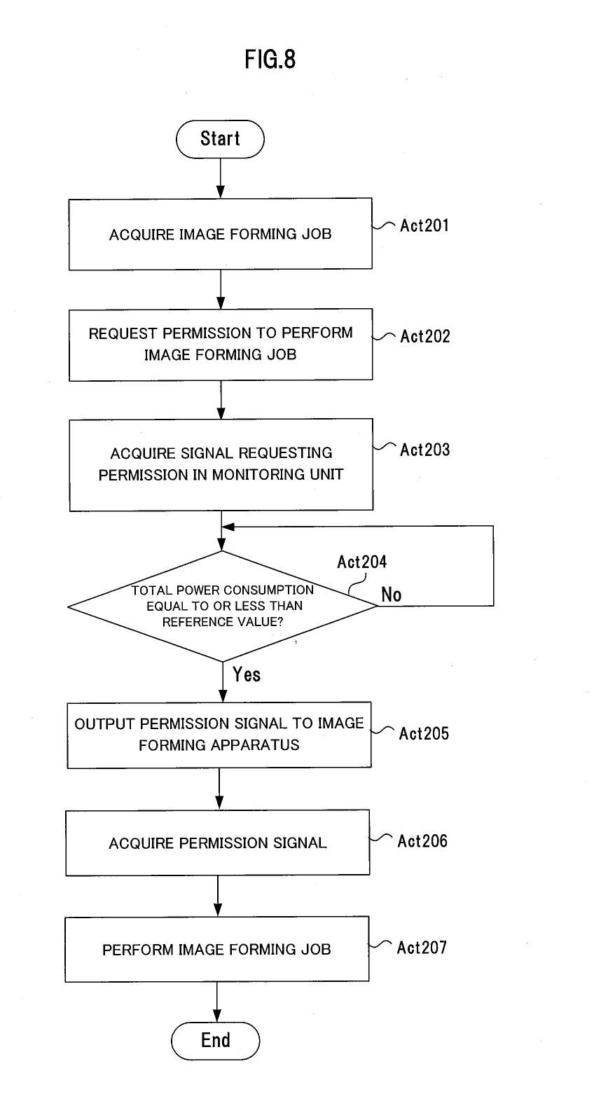

Next, the flow of an image forming process in a system of the embodiment is described. FIG. 8 is a flowchart showing the flow of an image forming process in a system of the embodiment.

First, the job acquiring unit 300 of the image forming apparatus 1′ acquires an image forming job (Act 201).

Next, the permission signal acquiring unit 308 requests a permission to perform the image forming job to the monitoring apparatus 150′ through the network 130 (Act 202).

Next, in the monitoring apparatus 150′, the permission request acquiring unit 204 acquires a signal that requests permission output from the image forming apparatus 1′ (Act 203).

The determining unit 206 of the monitoring apparatus 150′ acquires the total power consumption at the point of time which is monitored by the power consumption monitoring unit 200 and determines whether the total power consumption is equal to or less than a predetermined limiting power value (reference value) (Act 204).

When the total power consumption is equal to or less than the predetermined limiting power value (Yes in Act 204), the permission signal output unit 208 outputs a permission signal that permits performing of the image forming job to the image forming apparatus 1′ (Act 205).

Further, when the permission signal acquiring unit 308 of the image forming apparatus 1′ acquires the permission signal output from the monitoring apparatus 150′ (Act 206), the image forming process control unit 306 performs an image forming process, using the printer unit 10, on the basis of the image forming job (Act 207).

On the other hand, when the determining unit 206 determines that the total power consumption is larger than the limiting power value, in the monitoring apparatus 150′ (No in Act 204), a permission signal is not output and the determining unit 206 repeats the determining. When the total power consumption is equal to or less than the limiting power value, the permission signal output unit 208 outputs a permission signal, such that the image forming apparatus 1′ can perform the image forming job.

The above description is the flow of the image forming process in the embodiment.

Further, in the process flow described above, when it is determined that the total power consumption is larger than the limiting power value and the permission signal acquiring unit 308 fails to immediately acquire a permission signal, the image forming apparatus 1′ may stand by until a permission signal is acquired, and when a permission signal cannot be acquired even if a predetermined period passes from the request of the permission signal, the user may be informed that the image forming job cannot be performed and the image forming job may be canceled.

Further, although the monitoring apparatus 150′ is exemplified in the embodiment as an external apparatus that performs the process of determining whether the image forming apparatus 1 can perform an image forming job, it is not limited thereto. For example, individual external apparatuses, such as a server apparatus, which has the functions of the permission request acquiring unit 204, the determining unit 206, and the permission signal output unit 208, may be installed in the network 130. In this case, the permission signal acquiring unit 308 of the image forming apparatus 1′ requests permission to the server apparatus having the functions. Further, when the permission request acquiring unit 204 in the server apparatus acquires a signal that requests permission, the determining unit 206 acquires the total power consumption at the point of time from the monitoring apparatus 150 through the network 130 and determines whether the total power consumption is equal to or less than the limiting power value. Further, when the total power consumption is equal to or less than the limiting power value, the permission signal output unit of the server apparatus outputs a permission signal that permits performing of an image forming job to the image forming apparatus 1′. It is possible to implement the same functions as the function described in the embodiment, even using external apparatuses other than the monitoring unit, by the process described above.

Further, although the monitoring unit 150′ is exemplified in the embodiment that the power consumption monitoring unit 200 acquires the total power consumption of the monitoring target apparatuses, it is not limited thereto. It may be possible to control the image forming apparatus 1′ on the basis of current while monitoring current instead of the power.

Further, it may be possible to control the operation of the image forming apparatus on the basis of information that allows calculation of power consumption or current consumption, instead of the power consumption or the current consumption. For example, the monitoring apparatus 150′ may acquire information representing operation modes of the image forming apparatuses, which are monitoring targets, from the monitoring target apparatuses. Further, a database and the like that matches in advance the operation modes with the power (or current) that is consumed in the operation modes maybe stored. Further, when the monitoring apparatus 150′ acquires information representing an operation mode, power (current) corresponding to the operation mode may be acquired and the total power (current) consumption may be acquired with reference to the database. Similarly, in this case, the image forming apparatus 1′ can perform an image forming process without exceeding the maximum power.

### Third Embodiment

A third embodiment is described below. In the embodiment, although the monitoring apparatus outputs a signal that permits performing of an image forming job to the image forming apparatus, similar to the second embodiment, when the total power consumption is larger than the limiting power value and the image forming job cannot be performed, the total power consumption is decreased to and less than the limiting power value at as earlier timing as possible by changing the operation states of other apparatuses.

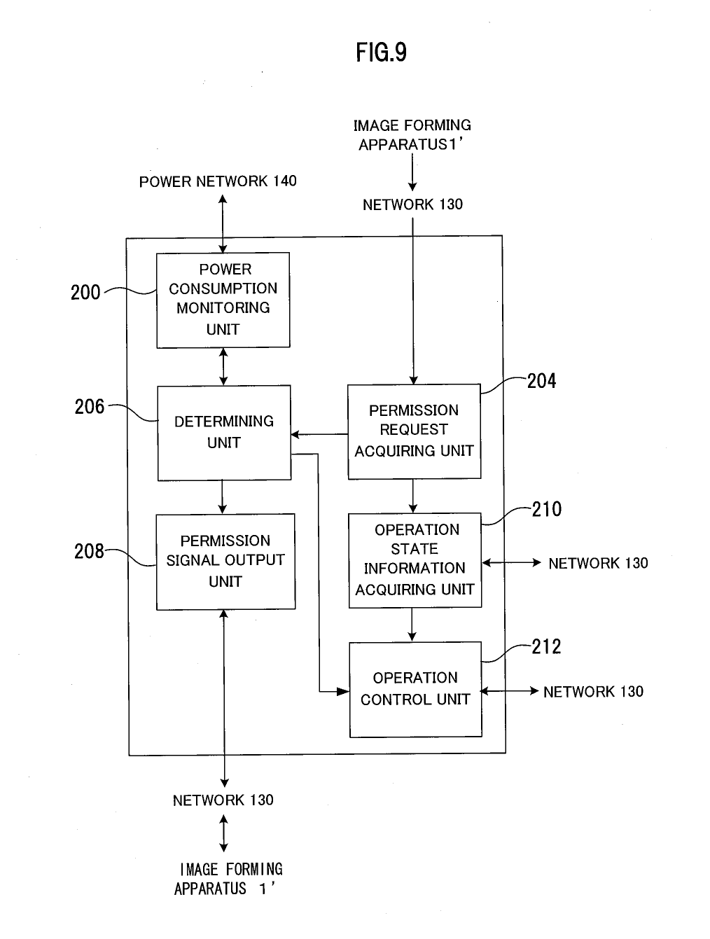

The function of a monitoring apparatus 150′ of the embodiment is described. FIG. 9 is a functional block diagram showing the function of the monitoring apparatus 150′ of the embodiment.

The monitoring apparatus 150′ of the embodiment includes a power consumption monitoring unit 200, a permission request acquiring unit 204, a determining unit 206, a permission signal output unit 208, an operation state information acquiring unit 210, and an operation control unit 212.

The power consumption monitoring unit 200 monitors the power consumption of monitoring target apparatuses, similar to the embodiments described above.

The permission request acquiring unit 204, the determining unit 206, and the permission signal output unit 208 have the same functions as those in the second embodiment, such that the description is not provided.

The operation state information acquiring unit 210 is a monitoring target apparatus of the monitoring apparatus 150′ and requests operation state information representing the operation modes of the image forming apparatus 1′ or other image forming apparatuses 100 to 104 and computers 120 and 122 to the apparatuses and acquires the information. In detail, the operation state information acquiring unit 210 acquires information representing a ready state, when the image forming apparatus 100 is the ready state, in which the image forming apparatus 100 can print immediately. Further, in a sleep state in which the temperature of a fixing device is low and the power consumption is smaller than the ready state, information representing the sleep state can be acquired. There may be information representing under-print or information representing a power-off state, as other items of information.

When the permission request acquiring unit 204 acquires a signal requesting permission to perform an image forming job from the image forming apparatus 1′ and the determining unit 206 performs determining, the operation control unit 212 determines that the total power consumption is larger than the limiting power value, and performs a process of decreasing the total power consumption by controlling the operations of other apparatuses when the image forming job cannot be performed.

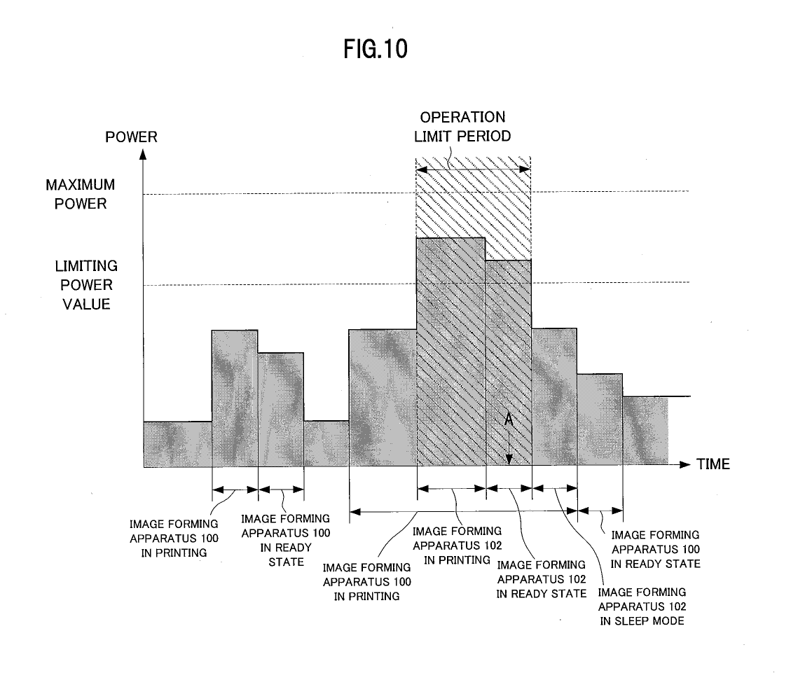

The function of the operation control unit 212 is described on the basis of FIG. 10. FIG. 10 is a diagram showing an example of transition of the total power consumption of the monitoring target apparatuses of the monitoring apparatus 150′. For example, at the timing indicated by an arrow A in FIG. 10, in the image forming apparatus 1′, an image forming job is generated, and when permission to perform the image forming job is requested from the image forming apparatus 1′, the determining unit 206 performs determining. In this case, as shown in FIG. 10, since the determining unit 206 determines that the total power consumption is larger than the limiting power value, the image forming job of the image forming apparatus 1′ is not permitted to be performed in this state.

In this case, as shown in FIG. 10, the operation state information acquiring unit 210 acquires information that the image forming apparatus 102 is in the ready state while another monitoring target apparatus, which is the image forming apparatus 100 is printing. Since the image forming apparatus 100 is printing, the operation state cannot be changed and the image forming apparatus 102 in the ready state is not printing.

When it is possible to decrease the total power consumption without stopping an image forming job, as described above, the operation control unit 212 can perform control of switching an operation mode of the image forming apparatus 102 in which power is supplied to heat the fixing device and the total power consumption increases, into an operation mode in which the power consumption is smaller than the ready state, for example, the sleep mode.

In the control of the operation control unit 210, when the image forming apparatus 102 proceeds to the sleep mode, as shown in FIG. 10, the total power consumption becomes equal to or less than the limiting power value, such that the image forming apparatus 1′ can perform the image forming job.

According to the embodiment described above, it is possible to efficiently perform an image forming process by distributing power to apparatuses, which further need the power, without increasing the total power consumption of the monitoring target apparatuses over the maximum power.

Further, external apparatuses, such as a server apparatus, other than the monitoring apparatus 150′ may also be provided with the function of the monitoring apparatus 150′ described above, in the embodiment.

According to the embodiments described above, it is possible to provide an image forming apparatus that allows more image forming processes, with limited power.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a job acquiring unit that acquires an image forming job giving an instruction to form an image;
an electricity consumption amount acquiring unit that acquires the sum of electricity consumption amount in a plurality of apparatuses of which the sum of electricity consumption amount including the electricity consumption amount of the image forming apparatus is limited at a predetermined maximum electricity consumption amount or less;
a determining unit that determines whether or not the sum of electricity consumption amount that the electricity consumption amount acquiring unit acquires is equal to or less than a predetermined reference value, which is smaller than the maximum electricity consumption amount; and
an image forming process control unit that performs an image forming job that the job acquiring unit acquires, when the determining unit determines that the sum of electricity consumption amount is equal to or less than the reference value.

2. The apparatus of claim 1,
wherein the electricity consumption amount is consumed power.

3. The apparatus of claim 1,
wherein the electricity consumption amount is consumed current.

4. The apparatus of claim 1,
wherein the reference value is at least as less as the electricity consumption amount required to perform an image forming process, than the maximum electricity consumption amount.

5. The apparatus of claim 1,
wherein the image forming process control unit stands by performing of the image forming job when the determining unit determines that the sum of electricity consumption amount is larger than the reference value, and then performs the image forming job when it is determined that the sum of electricity consumption amount is equal to or less than the reference value.

6. An image forming process control apparatus comprising:
an electricity consumption amount acquiring unit that acquires the sum of electricity consumption amount in a plurality of apparatuses of which the sum of electricity consumption amount is limited at a predetermined maximum electricity power consumption amount or less;
a permission request signal acquiring unit that acquires a signal that requests permission to perform an image forming job from any apparatus of the plurality of apparatuses;
a determining unit that determines whether the sum of electricity consumption amount acquired by the electricity consumption amount acquiring unit is equal to or less than a predetermined reference value smaller than the maximum electricity consumption amount, when the permission request signal acquiring unit acquires a signal that requests the permission; and
a permission signal output unit that outputs a permission signal that permits an apparatus, which outputs a signal requesting the permission, to perform the image forming job, when the determining unit determines that the sum of electricity consumption amount is equal to or less than the reference value.

7. The apparatus of claim 6,
wherein the electricity consumption amount is consumed power.

8. The apparatus of claim 6,
wherein the electricity consumption amount is consumed current.

9. The apparatus of claim 6,
wherein the reference value is at least as less as the electricity consumption amount required to perform an image forming process, than the maximum electricity consumption amount.

10. The apparatus of claim 6,
wherein permission signal output unit outputs a permission signal that permits performing of the image forming job when the determining unit determines that the sum of electricity consumption amount is larger than the reference value, and then when it is determined that the sum of electricity consumption amount is equal to or less than the reference value.

11. The apparatus of claim 6, further comprising:
an operation state information acquiring unit that acquires operation state information representing the operation states of the plurality of apparatuses; and
an operation control unit that, when there is an apparatus that does not perform an image forming process in the plurality of apparatuses, makes the operation state of the apparatus proceed to an operation state with less electricity consumption amount, on the basis of the operation state information acquired by the operation state information acquiring unit.

12. The apparatus of claim 6, further comprising:
an operation state information acquiring unit that acquires operation state information representing the operation states of the plurality of apparatuses,
wherein the electricity consumption amount acquiring unit calculates and acquires the sum of electricity consumption amount on the basis of operation state information on the plurality of apparatuses.

13. A method of controlling an image forming apparatus, comprising:
acquiring an image forming job giving an instruction to form an image;
acquiring the sum of electricity consumption amount in a plurality of apparatuses of which the sum of electricity consumption amount is limited at a predetermined maximum electricity consumption amount or less;
determining whether or not the acquired sum of electricity consumption amount is equal to or less than a predetermined reference value, which is smaller than the maximum electricity consumption amount; and
performing the acquired image forming job, when it is determined that the sum of electricity consumption amount is equal to or less than the reference value.

14. The method of claim 13,
wherein the electricity consumption amount is consumed power.

15. The method of claim 13,
wherein the electricity consumption amount is consumed current.

16. The method of claim 13,
wherein the reference value is at least as less as the electricity consumption amount required to perform an image forming process, than the maximum electricity consumption amount.

17. The method of claim 13,
wherein performing of the image forming job is stood by when it is determined that the sum of electricity consumption amount is larger than the reference value, and then the image forming job is performed when it is determined that the sum of electricity consumption amount is equal to or less than the reference value.

18. The method of claim 13, further comprising:
acquiring a signal that requests permission to perform the image forming job from any apparatus in the plurality of apparatuses;
outputting a permission signal that permits the apparatus, which outputs a signal requesting the permission, to perform the image forming job, when it is determined that the acquired sum of electricity consumption amount is equal to or less than the reference value; and
performing the image forming job on the basis of the permission signal.

19. The method of claim 13, further comprising:
acquiring operation state information representing the operation states of the plurality of apparatuses; and
when there is an apparatus that does not perform an image forming process in the plurality of apparatuses, making the operation state of the apparatus proceed to an operation state with electricity consumption amount less than when the operation state information is acquired, on the basis of the acquired operation state information.

20. The method of claim 13, further comprising:
acquiring operation state information representing the operation states of the plurality of apparatuses; and
calculating and acquiring the sum of electricity consumption amount on the basis of the operation state information of the plurality of apparatuses.
